(19) United States
(12) Patent Application Publication
(10) Pub. No.: US 2026/0127911 A1
(43) Pub. Date: May 7, 2026

(54) IMAGE PROCESSING METHOD AND APPARATUS, COMPUTER DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Jun WANG, Shenzhen (CN); Runzeng GUO, Shenzhen (CN); Shaoming WANG, Shenzhen (CN); Jingyun ZHANG, Shenzhen (CN)

(21) Appl. No.: 19/440,303

(22) Filed: Jan. 5, 2026

Related U.S. Application Data
(63) Continuation of application No. PCT/CN2025/100628, filed on Jun. 12, 2025.

(30) Foreign Application Priority Data
Jul. 15, 2024 (CN) 202410947867.1

(51) Int. Cl. G06V 40/12; G06V 10/74; G06V 10/77; G06V 10/82

(52) U.S. Cl. CPC G06V 40/1365; G06V 10/761; G06V 10/7715; G06V 10/82; G06V 40/1347

(57) ABSTRACT

This application discloses an image processing method performed by a computer device. The method includes: obtaining a first embedded feature of a first image, the first image being a palm print image; recognizing a target image type to which the first image belongs; obtaining an image feature set associated with the target image type, the image feature set including image embedded features of target images of a plurality of objects, each object in an object set having respective object identity information; obtaining a feature matching degree between the first embedded feature and each image embedded feature; and determining, among the plurality of objects, object identity information of an object whose associated image embedded feature has a highest feature matching degree with the first embedded feature for an object to which the first image belongs.

### CROSS-REFERENCE TO RELATED APPLICATIONS

This application is a continuation application of PCT Patent Application No. PCT/CN2025/100628, entitled “IMAGE PROCESSING METHOD AND APPARATUS, COMPUTER DEVICE, COMPUTER-READABLE STORAGE MEDIUM, AND COMPUTER PROGRAM PRODUCT” filed on Jun. 12, 2025, which is based upon and claims priority to Chinese Patent Application No. 2024109478671, entitled “IMAGE PROCESSING METHOD AND APPARATUS, COMPUTER DEVICE, COMPUTER-READABLE STORAGE MEDIUM, AND COMPUTER PROGRAM PRODUCT” filed on Jul. 15, 2024, both of which are incorporated herein by reference in their entirety.

### FIELD OF THE TECHNOLOGY

This application relates to the field of image processing technologies, and in particular, to an image processing method and apparatus, a computer device, a computer-readable storage medium, and a computer program product.

### BACKGROUND OF THE DISCLOSURE

In the field of performing user identity recognition based on a palm print image, a standard and perfect palm print image of a user may be acquired in advance and stored as a base image of the user, and subsequently, user identity recognition may be performed by using the stored base image. However, in a specific process of performing user identity recognition, a palm print image acquired in real time is random. Compared with the prestored base image, the palm print image acquired in real time may probably have inconsistency in terms of the posture, style, or the like, causing a large quantity of invalid comparisons and low recognition efficiency, and causing inconsistency between the palm print image acquired from the user in real time and the prestored base image of the user. Consequently, accurate user identity recognition cannot be implemented.

### SUMMARY

Embodiments of this application provide an image processing method and apparatus, a computer device, a computer-readable storage medium, and a computer program product, to improve accuracy of performing recognition on an identity of an object by using a palm print image.

An embodiment of this application provides an image processing method performed by a computer device, the method including:
obtaining a first embedded feature of a first image, the first image being a palm print image;
recognizing a target image type to which the first image belongs;
obtaining an image feature set associated with the target image type, the image feature set including image embedded features of target images of a plurality of objects, each object having respective object identity information;
determining a feature matching degree between the first embedded feature and each image embedded feature in the image feature set; and
determining, among the plurality of objects, object identity information of an object whose associated image embedded feature has a highest feature matching degree with the first embedded feature for an object to which the first image belongs.

An embodiment of this application provides a computer device, including a memory and a processor, the memory having a computer program stored therein, and the computer program, when executed by the processor, causing the computer device to perform the image processing method according to the embodiment of this application.

An embodiment of this application provides a non-transitory computer-readable storage medium, the computer-readable storage medium having a computer program stored therein, and the computer program, when executed by a processor of a computer device, causing the computer device to perform the foregoing image processing method.

According to embodiments of this application, a to-be-recognized first image and a first embedded feature of the first image may be obtained, the first image being a palm print image, and a target image type to which the first image belongs may be recognized from a plurality of set image types; an image feature set associated with the target image type may be obtained; the image feature set including image embedded features of target images of a plurality of objects, the target images being palm print images that belong to the target image type, and each object having respective object identity information; a feature matching degree between the first embedded feature and each image embedded feature may be obtained; and identity recognition information for an object to which the first image belongs may be determined based on the object identity information of each object and the feature matching degree between the first embedded feature and the image embedded feature. It can be learned that according to the method provided in embodiments of this application, a specific target image type to which the first image belongs may be first recognized, so that identity recognition on the object to which the first image belongs may be implemented by using a specific image feature set associated with the specific target image type and an embedded feature (for example, the first embedded feature) of the first image. Recognition in a specific range (for example, the image feature set associated with the target image type) is performed on an image considering a specific type of the image, so that interference from cross-type matching can be reduced, and accuracy of comparison between features of the same type can be improved, thereby implementing recognition on an identity of an object to which the image belongs. Thus, accuracy of identity recognition on the object by using the palm print image is improved. In addition, dynamic loading of the image feature set associated with the target image type can reduce a large quantity of invalid feature comparisons, to significantly improve recognition efficiency.

### BRIEF DESCRIPTION OF THE DRAWINGS

To describe technical solutions in embodiments of this application or in a related art more clearly, the following briefly introduces accompanying drawings for describing the embodiments or the related art. Apparently, the accompanying drawings in the following description show merely some embodiments of this application, and a person of ordinary skill in the art may still derive other drawings from the accompanying drawings without creative efforts.

FIG. 1 is a schematic structural diagram of a network architecture for image recognition according to an embodiment of this application.

FIG. 2 is a schematic diagram of a scenario of image recognition according to an embodiment of this application.

FIG. 3 is a schematic flowchart of an image processing method according to an embodiment of this application.

FIG. 4 is a schematic diagram of a scenario of performing image recognition by using a reference feature set according to an embodiment of this application.

FIG. 5 is a schematic flowchart of performing recognition on an identity of an object by using object identification information according to an embodiment of this application.

FIG. 6 is a schematic diagram of an interface for inputting object identification information according to an embodiment of this application.

FIG. 7 is a schematic diagram of a scenario of training a quality detection network according to an embodiment of this application.

FIG. 8 is a schematic flowchart of performing recognition on an identity of an object according to an embodiment of this application.

FIG. 9 is a schematic structural diagram of an image processing apparatus according to an embodiment of this application.

FIG. 10 is a schematic structural diagram of a computer device according to an embodiment of this application.

### DESCRIPTION OF EMBODIMENTS

Technical solutions of embodiments of this application will be clearly and completely described below with reference to the accompanying drawings of embodiments of this application. Apparently, the embodiments described are merely some embodiments rather than all embodiments of this application. All other embodiments obtained by a person of ordinary skill in the art based on embodiments of this application without creative efforts shall fall within the protection scope of embodiments of this application.

First, all data (relevant data such as an image, object identification information, object identity information, and an image embedded feature) acquired in embodiments of this application is acquired with consent and authorization of an owner (for example, a user, an organization, or an enterprise) of the data, and acquisition, use, and processing of relevant data need to comply with relevant laws, regulations, and standards of relevant regions.

Relevant technical concepts involved in embodiments of this application are described herein.
(1) Color image: A color image is acquired through natural light imaging by a color sensor, and may be configured for palm preference and comparison recognition during palm payment.
(2) Infrared image: An infrared image is acquired through flood infrared imaging by an infrared sensor, and may be configured for living body detection during palm payment.
(3) Support vector machine (SVM): A basic model of the SVM is defined as a linear classifier with a maximum margin in feature space.
(4) Palm print image: A palm print image is a digitalized representation of a human palm region (including biological features such as a palm skin texture, a major print line, a detail point, and a wrinkle) obtained through an image acquisition device, and an important data form in the field of biological feature recognition. The palm print image is unique, stable, and acquirable.
(5) Image embedded feature: An image embedded feature is numerical representation of mapping an original image to low-dimensional vector space by using a deep neural network or a feature extraction algorithm. The image embedded feature may be understood as a feature vector. The feature vector can compress and reserve key discriminative information (for example, a line structure of a palm print and distribution of detailed points) of the image, and can also eliminate redundancy (for example, eliminate interference such as illumination and a background).
(6) Associative storage: Associative storage is a process in which two or more data items (for example, a “reference embedded feature” and “identity identification information”) are bound in a logical relationship and stored persistently. A core objective thereof is to establish retrievable association between data, to facilitate subsequent query, analysis, and application.

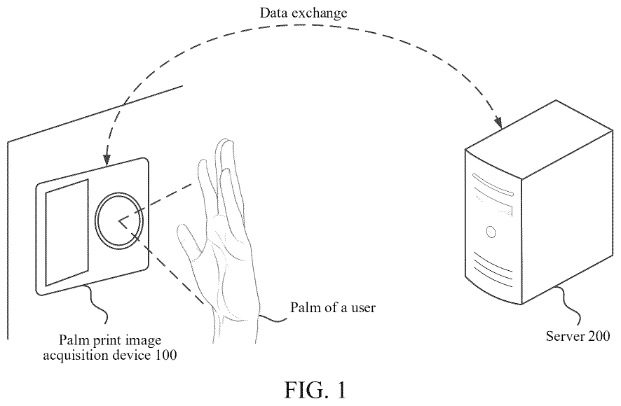

Refer to FIG. 1. FIG. 1 is a schematic structural diagram of a network architecture for image recognition according to an embodiment of this application. As shown in FIG. 1, the network architecture may include a palm print image acquisition device 100 and a server 200. The palm print image acquisition device 100 may be configured to acquire a palm print image of a user and report the palm print image to the server 200. The server 200 may be configured to perform recognition on the palm print image reported by the palm print image acquisition device 100. Therefore, a network connection may be established between the palm print image acquisition device 100 and the server 200, so that data exchange between the palm print image acquisition device 100 and the server 200 may be implemented via the network connection.

The server 200 shown in FIG. 1 may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The palm print image acquisition device 100 may be a terminal device of any type.

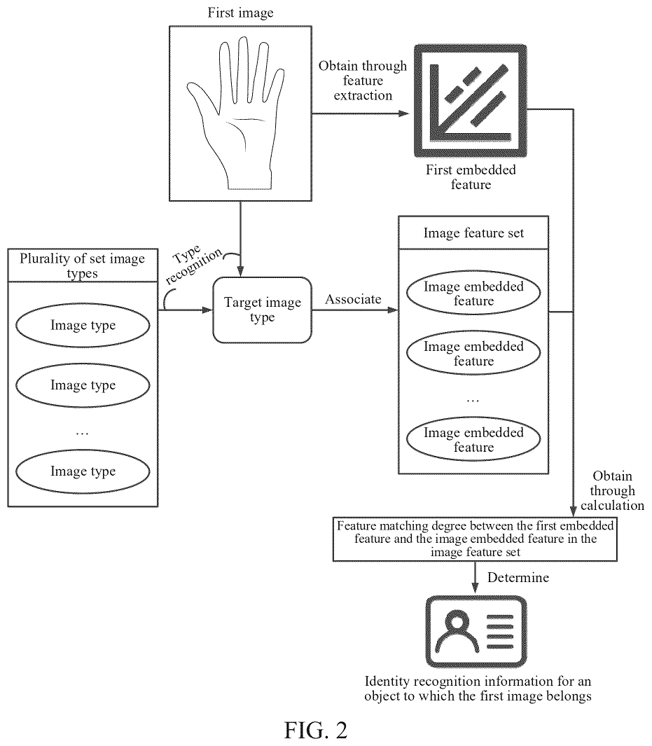

Refer to FIG. 2 together. FIG. 2 is a schematic diagram of a scenario of image recognition according to an embodiment of this application. As shown in FIG. 2, the palm print image acquired by the palm print image acquisition device 100 and reported to the server 200 may be a first image herein. The server 200 may perform feature extraction on the first image, to obtain a first embedded feature of the first image. The server 200 may further perform type recognition on the first image, to recognize, from a plurality of set image types, a target image type to which the first image belongs.

Further, the server 200 may further obtain an image feature set associated with the target image type. The image feature set may include image embedded features of images, of the target image type, of objects in an object set. The object in the object set may be a user who performs registration that links an object identity to the image on the server 200. Each object in the object set has registered (or bound) object identity information.

The server 200 may obtain a feature matching degree (which may be a feature similarity) between the first embedded feature of the first image and each image embedded feature in the image feature set through calculation. Therefore, the server 200 may determine, based on the object identity information of each object in the object set and the feature matching degree between the first embedded feature and the image embedded feature in the image feature set, identity recognition information for an object to which the first image belongs. The identity recognition information is identity information obtained through recognition on the object to which the first image belongs. For a specific process of identity recognition, refer to relevant description in the following embodiments.

According to the method provided in this embodiment of this application, due to randomness (for example, randomness of a palm inclined behavior, a palm pose and movement, a cleanliness state of a palm, or a status of a palm cover by the clothing) during palm print image photographing by the user, the acquired palm print image of the user is also random. Therefore, in this embodiment of this application, the plurality of set image types may be provided for the randomness, so that when identity recognition is performed on the object by using an image, an image type to which the currently acquired palm print image (for example, the first image) belongs is first recognized. In this way, specific recognition is performed on the palm print image for the recognized specific image type, and accuracy of recognition on the palm print image of the user is significantly improved.

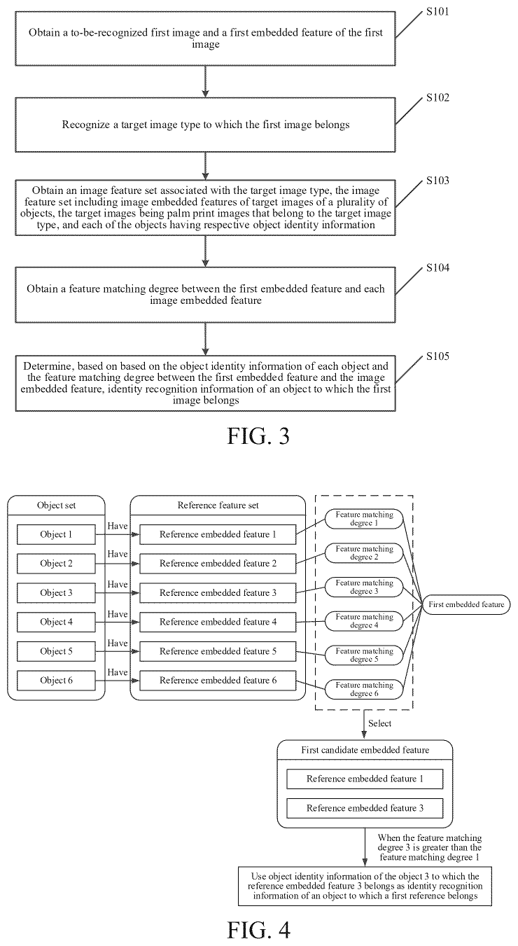

Refer to FIG. 3. FIG. 3 is a schematic flowchart of an image processing method according to an embodiment of this application. An execution entity in this embodiment of this application may be a computer device. The computer device may be a computer device or a computer device cluster including a plurality of computer devices. The computer device may be a server or a device of another type. This is not limited in this embodiment of this application. As shown in FIG. 3, the method may include the following operations.
Operation S101: Obtain a to-be-recognized first image and a first embedded feature of the first image.

In some embodiments, the computer device may obtain the to-be-recognized first image. The first image may be a palm print image acquired in real time on any object (for example, a user). In this embodiment of this application, an object identity of the object to which the first image belongs may be recognized by using the first image.

In some embodiments, the process of obtaining the to-be-recognized first image may include the following operations.

The computer device may obtain an acquired second image. The second image may be a palm print image acquired by a palm print image acquisition device. The palm print image acquisition device may send the acquired second image to the computer device. For example, the second image may be an image obtained by photographing a palm of the object by using a configured camera and an infrared ray of the palm print image acquisition device.

The computer device may perform feature extraction on the second image, to generate an image embedded feature of the second image. The image embedded feature may be referred to as a second embedded feature. For example, the computer device may perform feature extraction on the second image by using a trained first feature extraction network (which may be a deep learning network), to generate the second embedded feature of the second image.

The computer device may further obtain a reference feature set. The reference feature set may include a reference embedded feature of a reference image of an object in an object set in a reference pose. The reference image is a standard image with good quality acquired from the object. For example, the reference image may be a palm print image in which there is no dirt and obstruction, and a pose is basically parallel to the palm print image acquisition device without generating an excessively large angle.

The object set may be a user set. The objects in the object set may include all users who have completed palm print image registration. The user who has completed palm print image registration has a reference embedded feature of a reference image stored by the user. The reference embedded feature of the reference image stored by the user may be understood as a palm print image registered by the user. To ensure security and privacy of the palm print image of the user, when the user performs palm print image registration, the computer device generally does not directly store the palm print image acquired from the user, but stores an image embedded feature of the palm print image as a base image of the user.

Each object in the object set has a respective registered object identity information. As the name implies, the object identity information is configured for representing relevant information of an identity of the object. For example, the object identity information of the object may include relevant information such as a name, a gender, account information, and an identity number of the object.

The computer device may obtain a feature matching degree between the second embedded feature of the second image and each reference embedded feature in the reference feature set. The feature matching degree may be configured for reflecting a feature similarity between the second embedded feature and the reference embedded feature in the reference feature set. There may be one feature matching degree between the second embedded feature and one reference embedded feature in the reference feature set. A larger feature matching degree indicates a higher similarity between the second embedded feature and the reference embedded feature in the reference feature set. On the contrary, a smaller feature matching degree indicates a lower similarity between the second embedded feature and the reference embedded feature in the reference feature set.

For example, the image embedded feature of the palm print image may be a feature vector. A cosine similarity between the second embedded feature and each reference embedded feature in the reference feature set may be calculated by the computer device, to be used as a feature matching degree between the second embedded feature and the reference embedded feature in the reference feature set.

In some embodiments, a Euclidean distance between the second embedded feature and each reference embedded feature may be determined, to be used as a feature matching degree between the second embedded feature and the reference embedded feature; a Manhattan distance between the second embedded feature and each reference embedded feature may be determined, to be used as a feature matching degree between the second embedded feature and the reference embedded feature; and a Hamming distance between the second embedded feature and each reference embedded feature may be determined, to be used as a feature matching degree between the second embedded feature and the reference embedded feature. A manner of determining a feature matching degree is not limited in this embodiment of this application.

Further, the computer device may evaluate a feature matching degree between the second embedded feature and each reference embedded features. If the feature matching degree between the second embedded feature and the reference embedded feature is less than a first matching degree threshold, it may indicate that recognition on an identity of an object to which the second image belongs by using the reference feature set fails, that is, a reference embedded feature matching the second embedded feature does not exist in the reference feature set. In this case, the second image may be used as the first image, and the recognition process described in this embodiment of this application is performed on the first image, that is, the recognition process described in this embodiment of this application is further performed on the second image.

The first matching degree threshold may be set based on an actual application scenario. The first matching degree threshold may be a minimum feature matching degree configured for evaluating that the second embedded feature matches a reference embedded feature in the reference feature set.

However, if a reference embedded feature whose feature matching degree with the second embedded feature is greater than or equal to the first matching degree threshold exists in the reference feature set, the computer device may select, from the reference feature set, the reference embedded feature whose feature matching degree with the second embedded feature is greater than or equal to the first matching degree threshold as a first candidate embedded feature. In this case, there may be one or more first candidate embedded features.

Therefore, an object to which a first candidate embedded feature having a largest feature matching degree with the second embedded feature belongs may be used by the computer device as a first recognition object. The first recognition object is an object obtained by recognizing the object to which the second image belongs by using the second image. The first candidate embedded feature having the largest feature matching degree with the second embedded feature may be understood as a reference embedded feature in the reference feature set that matches the second embedded feature. In this case, it may be considered that the second embedded feature and the first candidate embedded feature having the largest feature matching degree with the second embedded feature are the image embedded features of the palm print image of the same object (for example, the same user).

Therefore, the computer device may use object identity information of the first recognition object as identity recognition information for the object to which the second image belongs. In this case, identity recognition on the object to which the second image belongs by using the reference feature set succeeds, and there is no need to further perform secondary recognition on the second image, that is, there is no need to use the second image as the first image, and further perform the recognition process described in this embodiment of this application. In this way, recognition operations can be reduced, and recognition efficiency can be improved, thereby improving service execution efficiency.

It may be learned that the first image and the second image are the same image, and when object identity recognition on the object to which the second image belongs by using the reference feature set fails, the second image may be used as the first image, to further perform accurate secondary recognition on the first image.

Refer to FIG. 4. FIG. 4 is a schematic diagram of a scenario of performing image recognition by using a reference feature set according to an embodiment of this application. As shown in FIG. 4, it is assumed that the object set may include six objects: an object 1, an object 2, an object 3, an object 4, an object 5, and an object 6. Therefore, the reference feature set may include a reference embedded feature 1 of a reference image of the object 1, a reference embedded feature 2 of a reference image of the object 2, a reference embedded feature 3 of a reference image of the object 3, a reference embedded feature 4 of a reference image of the object 4, a reference embedded feature 5 of a reference image of the object 5, and a reference embedded feature 6 of a reference image of the object 6.

The computer device may obtain a feature matching degree 1 between the first embedded feature and the reference embedded feature 1, a feature matching degree 2 between the first embedded feature and the reference embedded feature 2, a feature matching degree 3 between the first embedded feature and the reference embedded feature 3, a feature matching degree 4 between the first embedded feature and the reference embedded feature 4, a feature matching degree 5 between the first embedded feature and the reference embedded feature 5, and a feature matching degree 6 between the first embedded feature and the reference embedded feature 6.

If among the feature matching degree 1, the feature matching degree 2, the feature matching degree 3, the feature matching degree 4, the feature matching degree 5, and the feature matching degree 6, only the feature matching degree 1 and the feature matching degree 3 are greater than or equal to the first matching degree threshold, the reference embedded feature 1 and the reference embedded feature 3 may be used as first candidate embedded features.

Further, if the feature matching degree 3 is greater than the feature matching degree 1, object identity information of the object 3 to which the reference embedded feature 3 belongs may be directly used as identity recognition information for the object to which the first image belongs.

However, if the feature matching degree 1, the feature matching degree 2, the feature matching degree 3, the feature matching degree 4, the feature matching degree 5, and the feature matching degree 6 are all less than the first matching degree threshold, the second image may be used as the first image, and identity recognition is performed after image type recognition.

The computer device may obtain the first embedded feature of the first image. In some embodiments, the first embedded feature may be the second embedded feature. Alternatively, different image embedded features of the palm print image may be used at different image recognition stages. Therefore, the computer device may perform feature extraction on the first image by using a trained second feature extraction network (or a deep learning network), to generate the first embedded feature of the first image. The trained second feature extraction network may be different from the trained first feature extraction network. In this case, the first embedded feature and the second embedded feature are different.

Different feature extraction networks are used at different palm print image recognition stages (for example, a stage of performing palm print image recognition by using the reference feature set and a stage of performing palm print image recognition by using an image type in this embodiment of this application) to generate different image embedded features of the same palm print image, so that recognition may be performed by using the different image embedded features of the same palm print image at the different image recognition stages. Therefore, styles and dimensions of the image embedded features of the same palm print image can be enriched, to implement more accurate and comprehensive recognition on the same palm print image.
Operation S102: Recognize a target image type to which the first image belongs.

In some embodiments, the computer device may obtain a trained multi-classification network. The trained multi-classification network may be a trained network that can perform type recognition (that is, perform classification) on images of a plurality of set image types. The trained multi-classification network may be obtained by performing supervised training by using sample images of the plurality of set image types (sample images with labels of the image types). For example, the trained multi-classification network may be an SVM network (a generalized linear classifier using a supervised learning manner).

Therefore, the computer device may recognize an image type (or referred to as a type label) to which the first image belongs by using the trained multi-classification network, and the image type recognized on the first image may be referred to as the target image type. In some embodiments, the computer device may input the first image into the trained multi-classification network, to invoke the trained multi-classification network to recognize, from the plurality of set image types, the target image type to which the first image belongs.

Alternatively, the plurality of image types may include a first image type. The first image type may be a type in which an angle between a palm and the palm print image acquisition device is larger than a specific angle threshold. The first image type may be recognized in a particular manner, including the following operations.

The computer device may obtain a target angle between an image plane (which may be a plane formed by three points on the first image) corresponding to the first image and a coordinate system in which the palm print image acquisition device is located. In some embodiments, the target angle may be obtained through detection by the palm print image acquisition device that acquires the first image, and sent to the computer device. A position of a camera component of the palm print image acquisition device may be an origin of the coordinate system in which the palm print image acquisition device is located.

If the target angle is larger than the set angle threshold, the computer device may consider the target image type to which the first image belongs as a large-angle image type. In some embodiments, the target angle may include a pitch angle and a roll angle. Both the pitch angle and the roll angle are configured for describing an angle between a plane and a coordinate system in space. Angle thresholds corresponding to the pitch angle and the roll angle may be respectively set. If the pitch angle and the roll angle are respectively greater than the corresponding angle thresholds thereof, it may be considered that the target angle is greater than the set angle threshold.

Alternatively, in this case, the trained multi-classification network may alternatively be trained by using a sample image of an image type (a sample image with a label of the image type) other than the first image type in the plurality of set image types. Therefore, the trained multi-classification network may be configured to perform type recognition (that is, perform classification) on an image of an image type other than the first image type in the plurality of set image types.

Therefore, the computer device may recognize the image type to which the first image belongs by using the target angle and the trained multi-classification network. In this case, determining priorities may be respectively set for the first image type and other image types (namely, the image type other than the first image type in the plurality of image types), so that when the target angle is detected to be larger than the angle threshold and any one of the other image types is recognized by using the trained multi-classification network, the target image type to which the first image belongs may be finally determined based on the determining priorities.

For example, when the target angle is detected to be larger than the angle threshold and any one of the other image types is recognized by using the trained multi-classification network, if the determining priority of the first image type is higher than the determining priority of the another image type, the first image type may be used as the finally recognized target image type of the first image.

For another example, when the target angle is detected to be larger than the angle threshold and any one of the other image types is recognized by using the trained multi-classification network, if the determining priority of the first image type is lower than the determining priority of the another image type, the another image type recognized by using the trained multi-classification network may be used as the finally recognized target image type of the first image.

According to the foregoing process, the target image type to which the first image belongs may be recognized from the plurality of set image types. Alternatively, in an actual application scenario, the image type of the image may be recognized by using another recognition method. This is not limited in this application.

For example, the plurality of set image types may include a second image type (representing that the photographed palm is dirty), a third image type (representing that the photographed palm is partially covered), the first image type, a fourth image type (representing that light is weak when the image is photographed), a fifth image type (representing that the photographed image is exposed), a seventh image type (representing that the photographed image is distorted), an eighth image type (in addition to the palm print image, the photographed image in this embodiment of this application further includes a vein image photographed through an infrared ray, and the eighth image type represents that a vein is weak), and the like. Similarly, in an actual application scenario, more image types may be set. This is not limited in this embodiment of this application. The palm print image may be a color image, and the vein image may be an infrared image.
Operation S103: Obtain an image feature set associated with the target image type, the image feature set including image embedded features of target images of a plurality of objects, the target images being palm print images that belong to the target image type, and each object having respective object identity information.

In some embodiments, the computer device may obtain the image feature set associated with the target image type. The image feature set includes the image embedded features of the target images of the plurality of objects in the object set, and the target images are palm print images that belong to the target image type. In other words, the image feature set may include the image embedded features of the palm print images of the target image type previously acquired from the objects in the object set.

The target image type may be any one of the plurality of image types, each image type of the plurality of image types may have a respective associated image feature set, and an image feature set associated with an image type may include image embedded features of images of a plurality of objects in the image type. In some embodiments, the image feature set associated with each image type may be obtained through feature extraction on images of the objects in the object set in each image type by using the trained second feature extraction network.
Operation S104: Obtain a feature matching degree between the first embedded feature and each image embedded feature.

In some embodiments, the computer device may obtain the feature matching degree between the first embedded feature of the first image and each image embedded feature in the image feature set associated with the target image type. There may be one feature matching degree between the first embedded feature and one image embedded feature in the image feature set. In some embodiments, the feature matching degree between the first embedded feature and the image embedded feature in the image feature set associated with the target image type may alternatively be a cosine similarity between the first embedded feature and the image embedded feature in the image feature set.

Similarly, the feature matching degree between the first embedded feature and the image embedded feature in the image feature set associated with the target image type may be configured for reflecting a feature similarity between the first embedded feature and the image embedded feature in the image feature set. A larger feature matching degree between the first embedded feature and the image embedded feature in the image feature set associated with the target image type indicates a higher similarity between the first embedded feature and the image embedded feature in the image feature set. On the contrary, a smaller feature matching degree between the first embedded feature and the image embedded feature in the image feature set associated with the target image type indicates a lower similarity between the first embedded feature and the image embedded feature in the image feature set.
Operation S105: Determine, based on the object identity information of each object and the feature matching degree between the first embedded feature and the image embedded feature, identity recognition information for an object to which the first image belongs.

In some embodiments, if an image embedded feature whose feature matching degree with the first embedded feature is greater than or equal to a second matching degree threshold exists in the image feature set associated with the target image type, the computer device may select, from the image feature set associated with the target image type, the image embedded feature whose feature matching degree with the first embedded feature is greater than or equal to the second matching degree threshold as a second candidate embedded feature. In this case, there may be one or more second candidate embedded features. The second matching degree threshold may be set based on an actual application scenario. For example, the second matching degree threshold may be equal to the first matching degree threshold. The second matching degree threshold may be a minimum feature matching degree configured for evaluating that the first embedded feature matches the image embedded feature in the image feature set associated with the target image type.

Therefore, an object to which a second candidate embedded feature having a largest feature matching degree with the first embedded feature belongs may be used by the computer device as a second recognition object. The second recognition object is an object obtained by recognizing the object to which the first image belongs by using the first image. The second candidate embedded feature having the largest feature matching degree with the first embedded feature may be understood as the image embedded feature in the image feature set associated with the target image type that matches the first embedded feature. In this case, it may be considered that the first embedded feature and the second candidate embedded feature having the largest feature matching degree with the first embedded feature are the image embedded features of the images of the same object (for example, the same user).

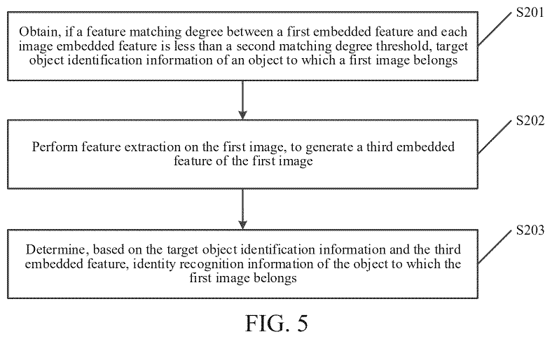

Therefore, object identity information of the second recognition object may be used by the computer device as the identity recognition information for the object to which the first image belongs. In this case, identity recognition on the object to which the first image belongs by using the image feature set associated with the target image type succeeds, and there is no need to further perform tertiary recognition on the first image. For example, there is no need for the user (the object to which the first image belongs) to input object identification information into the palm print image acquisition device, to further perform recognition on the object identity of the object to which the first image belongs by using the input object identification information. For a specific process of further performing identity recognition on the object to which the first image belongs by using the object identification information input by the user, refer to description in the following embodiment corresponding to FIG. 5.

If the feature matching degree between the first embedded feature and the image embedded feature in the image feature set associated with the target image type is less than the second matching degree threshold, it may indicate that identity recognition on the object to which the first image belongs by using the image feature set associated with the target image type fails, that is, an image embedded feature matching the first embedded feature does not exist in the image feature set associated with the target image type. In this case, the user needs to input registered object identification information, to perform further 1v1 recognition (namely, 1-to-1 recognition) on the identity of the object to which the first image belongs by using the input object identification information. For the specific recognition process, refer to relevant description in the following embodiment corresponding to FIG. 5.

According to the method provided in this embodiment of this application, for an image difference due to a specific reason (for example, a different behavior or pose of photographing the palm print image) of the user, secondary recognition is performed on the palm print image of the user in a corresponding image type, to effectively alleviate palm recognition failure due to the specific reason. Finally, a success rate of recognizing the palm of the user is improved, and experience degrading due to additional verification on a mobile phone number (namely, the object identification information) input by the user can be alleviated, so that user experience is effectively improved.

According to embodiments of this application, a to-be-recognized first image and a first embedded feature of the first image may be obtained; a target image type to which the first image belongs may be recognized from a plurality of set image types; an image feature set associated with the target image type may be obtained; the image feature set including image embedded features of target images of a plurality of objects, the target images being palm print images that belong to the target image type, and each object in the object set having respective object identity information; a feature matching degree between the first embedded feature and each image embedded feature in the image feature set may be obtained; and identity recognition information for an object to which the first image belongs may be determined based on the object identity information of each object and the feature matching degree between the first embedded feature and the image embedded feature in the image feature set. It can be learned that according to the method provided in embodiments of this application, a specific target image type to which the first image belongs may be first recognized, so that identity recognition on the object to which the first image belongs may be implemented by using a specific image feature set associated with the specific target image type and an embedded feature (for example, the first embedded feature) of the first image. Recognition in a specific range (for example, the image feature set associated with the target image type) is performed on an image considering a specific type of the image, so that interference from cross-type matching can be reduced, and accuracy of comparison between features of the same type can be improved, thereby implementing recognition on an identity of an object to which the image belongs. Thus, accuracy of identity recognition on the object by using the palm print image is improved. In addition, dynamic loading of the image feature set associated with the target image type can reduce a large quantity of invalid feature comparisons, to significantly improve recognition efficiency.

Refer to FIG. 5. FIG. 5 is a schematic flowchart of performing recognition on an identity of an object by using object identification information according to an embodiment of this application. An execution entity in this embodiment of this application may also be the foregoing computer device. As shown in FIG. 5, the flowchart may include the following operations.
Operation S201: Obtain, if a feature matching degree between a first embedded feature and each image embedded feature is less than a second matching degree threshold, target object identification information of an object to which a first image belongs.

In some embodiments, if a feature matching degree between the first embedded feature and each image embedded feature in an image feature set associated with a target image type is less than the second matching degree threshold, the computer device may send, to a palm print image acquisition device, prompt information indicating that object identification information needs to be input, so that the palm print image acquisition device may display an input interface for inputting the registered object identification information by the user, and the palm print image acquisition device may obtain, from the input interface, the object identification information input by the user (for example, the object to which the first image belongs). For example, the object identification information may be a communication number (for example, a mobile phone number) of the user.

The palm print image acquisition device may send the obtained object identification information to the computer device, so that the computer device may also receive the object identification information that is input by the user and that is for the object to which the first image belongs. The obtained object identification information may be referred to as the target object identification information.

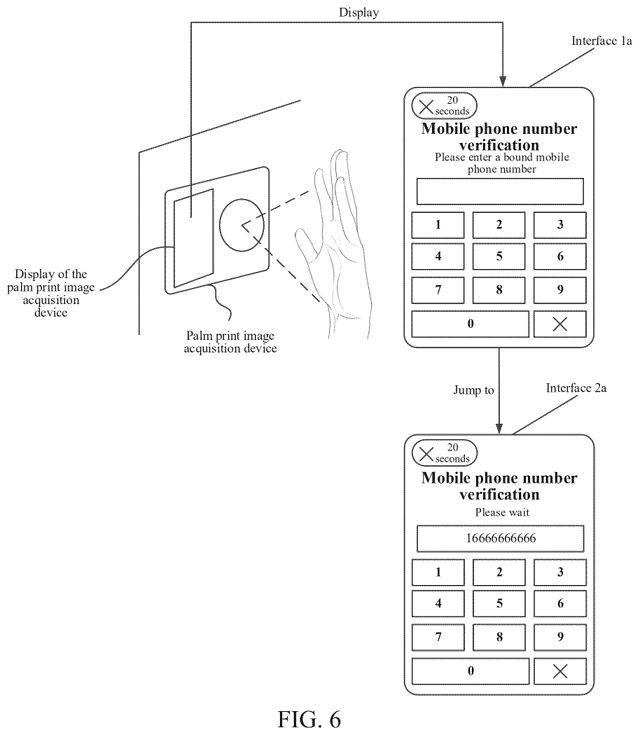

Refer to FIG. 6. FIG. 6 is a schematic diagram of an interface for inputting object identification information according to an embodiment of this application. As shown in FIG. 6, it is assumed that the object identification information of the object is a registered (that is, bound) mobile phone number of the object, and the palm print image acquisition device may have a touchable display. When the user needs to input the object identification information, the palm print image acquisition device may display an interface 1a on the display. The interface 1a is an interface for inputting the mobile phone number. The user may input the mobile phone number in the interface 1a, and when finished, the display of the palm print image acquisition device may jump to an interface 2a. The interface 2a may prompt the user that an identity of the user is being recognized by using the input mobile phone number (where the recognition process may be performed by the computer device). After user identity recognition by the computer device succeeds subsequently, the computer device may further return prompt information of successful recognition to the palm print image acquisition device. The palm print image acquisition device may output the prompt information of successful recognition, to prompt the user that identity recognition succeeds, or directly prompt the user that a related service (for example, a target service described below) is successfully executed.
Operation S202: Perform feature extraction on the first image, to generate a third embedded feature of the first image.

In some embodiments, if the first embedded feature is the same as the second embedded feature, the third embedded feature may also be the same as the first embedded feature and the second embedded feature. That is, the first embedded feature, the second embedded feature, and the third embedded feature may be the same embedded feature, and all may be the second embedded feature that is generated first, so that workload of obtaining the three embedded features, namely the first embedded feature, the second embedded feature, and the third embedded feature can be reduced.

If the first embedded feature is different from the second embedded feature, the third embedded feature may also be different from the first embedded feature and the second embedded feature. For example, the computer device may invoke a trained third feature extraction network to perform feature extraction on the first image, to generate the third embedded feature of the first image. The trained third feature extraction network, the trained first feature extraction network, and the trained second feature extraction network all may be different feature extraction networks. For example, the trained first feature extraction network, the trained second feature extraction network, and the trained third feature extraction network may be respectively obtained through training by using different sample images and in different training manners, or/and the trained first feature extraction network, the trained second feature extraction network, and the trained third feature extraction network may respectively have different network structures (for example, models of different types).

In this case, the different image embedded features of the same image (namely, the second image) are used at different image recognition stages (for example, a stage of performing image recognition by using the reference feature set, a stage of performing image recognition by using the image type, and a stage of performing image recognition by using the object identification information) in this embodiment of this application to perform image recognition, so that the styles and dimensions of the image embedded features of the same image are enriched, so as to implement more accurate and comprehensive recognition on the same palm print image, thereby improving a success rate and accuracy of identity recognition on the object.
Operation S203: Determine, based on the target object identification information and the third embedded feature, the identity recognition information for the object to which the first image belongs.

In some embodiments, each object in the object set may have a respective image embedded feature of the reference image in the reference pose. For example, the reference feature set includes the image embedded features of the reference images of the objects. Moreover, the image embedded feature of the reference image of each object may be stored in association with the object identification information of each object (which may be associatively stored in a background, for example, stored in the computer device or stored in a database accessible to the computer device). The associative storage may also be understood as that an image embedded feature of a reference image of an object has a mapping relationship with a registered object identification information of the object.

Therefore, the computer device may obtain a reference embedded feature that is in the reference embedded features (namely, the reference feature set) of the reference images of the plurality of objects and that is stored in association with the target object identification information. The obtained reference embedded feature stored in association with the target object identification information may be referred to as a target embedded feature. The target embedded feature is a reference embedded feature of a reference image of the user to which the input target object identification information belongs.

Therefore, the computer device may obtain a feature matching degree between the target embedded feature and the third embedded feature. For example, the feature matching degree between the target embedded feature and the third embedded feature may alternatively be a cosine similarity between the target embedded feature and the third embedded feature.

If the feature matching degree between the target embedded feature and the third embedded feature is greater than or equal to a third matching degree threshold, it indicates that the target embedded feature matches the third embedded feature. Object identity information of an object to which the target embedded feature belongs may be used by the computer device as the identity recognition information for the object to which the first image belongs. In this way, the object identity of the object to which the first image belongs is successfully recognized. The third matching degree threshold may be a minimum feature matching degree configured for evaluating that the target embedded feature matches the third embedded feature. The third matching degree threshold may be set based on an actual application scenario.

When the identity of the user is recognized by using the target embedded feature, it indicates that the target object identification information input by the user corresponds to the object identification information registered by the user. Therefore, in this process, a requirement for performing user identity recognition by using the third embedded feature may be reduced. For example, the third matching degree threshold configured for evaluating that the target embedded feature matches the third embedded feature may be appropriately reduced. Therefore, the third matching degree threshold may be less than the first matching degree threshold, and less than the second matching degree threshold.

If the feature matching degree between the target embedded feature and third embedded feature is less than the third matching degree threshold, it indicates that the target embedded feature does not match the third embedded feature. In this case, recognition on the object identity of the object to which the first image belongs fails, and the computer device generates recognition failure information. In some embodiments, the recognition failure information may be used by the computer device as the identity recognition information for the object to which the first image belongs.

The computer device may return the recognition failure information to the palm print image acquisition device, so that when receiving the recognition failure information, the palm print image acquisition device may output prompt information indicating that image acquisition needs to be performed again, to prompt the user (for example, the object to which the first image belongs) to enter an image again, and perform identity recognition by using the entered image again. That is, the currently entered second image does not meet a specification.

Alternatively, in some embodiments, when inputting the object identification information, the user may input only part of identification information of the target object identification information (for example, only last four bits of the target object identification information of the user), so that the computer device may select reference embedded features of reference images of objects to which object identification information whose identification information at a corresponding location (for example, the last four bits) is the same as the part of identification information input by the user belongs. The selected reference embedded features may form a reference feature subset, so that final identity recognition may be performed on the user by using the reference feature subset. In this process, a matching degree threshold (for example, a fourth matching degree threshold) may also be set, for evaluating a matching degree between the third embedded feature and a reference embedded feature in the reference feature subset. The fourth matching degree threshold is a minimum feature matching degree configured for evaluating that the third embedded feature matches the reference embedded feature in the reference feature subset.

The principle of performing recognition on the object identity of the object to which the first image belongs by using the third embedded feature, the fourth matching degree threshold, and the reference feature subset is the same as the principle of performing recognition on the object identity of the object to which the first image belongs by using the first embedded feature, the second matching degree threshold, and the image feature set associated with the target image type. Recognition on the object identity of the object to which the first image belongs by using the third embedded feature, the fourth matching degree threshold, and the reference feature subset is performed when the part of identification information input by the user corresponds to part of identification information of the object identification information registered by the user. Therefore, the fourth matching degree threshold may be less than the second matching degree threshold. However, because only part of identification information is input, compared with the third matching degree threshold when complete target object identification information is input to perform object identity recognition, the fourth matching degree threshold may be greater than the third matching degree threshold.

In some embodiments, if the feature matching degree between the target embedded feature and the third embedded feature is greater than or equal to the third matching degree threshold, it indicates that an embedded feature extracted from the first image matches, to some extent, the reference embedded feature of the reference image of the object to which the first image belongs. In this case, the computer device may further detect image quality of the first image.

If the image quality of the first image meets a set quality standard, the computer device may store any one of the first embedded feature, the second embedded feature, and the third embedded feature as an image embedded feature of an image of the object to which the first image belongs in the target image type, for subsequent identity recognition on the object in the target image type. In some embodiments, an embedded feature of an identity recognition stage that is stored (to be specific, an embedded feature of the first embedded feature, the second embedded feature, and the third embedded feature that is stored) as the image embedded feature of the image of the object to which the first image belongs in the target image type may be set based on an actual application scenario.

If the image quality of the first image does not meet the set quality standard, it indicates that the first image is not suitable for storage of the embedded feature as a base image of the object. In this case, the computer device may reject to store the embedded feature of the first image, for example, reject to store the first embedded feature, the second embedded feature, and the third embedded feature.

In some embodiments, a manner of detecting the image quality of the first image by the computer device may include the following operations.

The computer device may obtain a trained quality detection network. The trained quality detection network may be a trained network (or a deep learning network) that can perform quality detection on the image. The computer device may input the first image into the trained quality detection network, to invoke the trained quality detection network to perform quality detection on the first image, so as to generate a quality parameter (which may be a quality score) of the first image. The quality parameter of the first image may be configured for reflecting the image quality of the first image. A higher quality parameter of the first image indicates better image quality of the first image. On the contrary, a lower quality parameter of the first image indicates poorer image quality of the first image.

Thus, the set quality standard may include a set quality parameter threshold. The quality parameter threshold may be a minimum quality parameter configured for evaluating that the image quality complies with the quality standard. Therefore, if the quality parameter of the first image is greater than or equal to the quality parameter threshold, the computer device may determine that the image quality of the first image meets the set quality standard, that is, determine that the image quality of the first image is good. If the quality parameter of the first image is less than the quality parameter threshold, the computer device may determine that the image quality of the first image does not meet the set quality standard, that is, determine that the image quality of the first image is poor.

For example, in some embodiments, a manner of training the trained quality detection network by the computer device may include the following operations.

The computer device may obtain a to-be-trained quality detection network and a sample data set for training the quality detection network. The sample data set may include N groups of sample data, N being a positive integer. One group of sample data may include a to-be-detected sample image and a standard image of a sample palm to which the sample image belongs. One group of sample data may include a plurality of to-be-detected sample images, and the plurality of sample images may correspond to the same standard image. The standard image is a standard image with good image quality. The sample images in one group of sample data and the standard image corresponding to the sample images are all images of a palm of the same sample object (for example, a sample user). The sample images in the group of sample data may be various images (for example, images of various image types, and the sample images may be images in which obstruction, dirt, a weak vein, exposure, weak light, and the like may occur) photographed on the palm of the sample object. The standard image corresponding to the sample images may be similar to the reference image, and is an image with good image quality in the reference pose.

The computer device may further obtain a trained similarity recognition network. The trained similarity recognition network may be a network that can recognize a similarity between images and that is obtained through pre-training. A network structure of the trained similarity recognition network may be selected based on an actual application scenario. This is not limited in this embodiment of this application.

The computer device may invoke the trained similarity recognition network to separately perform recognition on similarities between the sample images and a corresponding standard image in each group of sample data, to generate a similarity parameter (which may be a similarity score, or referred to as recognition score) between a sample image and a corresponding standard image in each group of sample data. There may be one similarity parameter between one sample image in one group of sample data and a corresponding standard image. The similarity parameter is configured for evaluating a similarity between the sample image and the corresponding standard image. For example, a larger similarity parameter indicates a higher similarity between the sample image and the corresponding standard image. On the contrary, a smaller similarity parameter indicates a lower similarity between the sample image and the corresponding standard image.

The computer device may further invoke the to-be-trained quality detection network to separately perform quality detection on the sample images in the group of sample data, to generate quality parameters of the sample images in the group of sample data. One sample image in one group of sample data may have one quality parameter.

Therefore, the computer device may update a network parameter of the to-be-trained quality detection network based on the similarity parameters of the sample images in the group of sample data and the corresponding standard image and the quality parameters of the sample images in the group of sample data, to obtain the trained quality detection network.

A manner of updating the network parameter of the to-be-trained quality detection network may include: updating the network parameter of the to-be-trained quality detection network, to cause first parameter distribution to approach second parameter distribution. The first parameter distribution may be parameter distribution formed by the quality parameters generated on the sample images in the N groups of sample data by the to-be-trained quality detection network, and the second parameter distribution may be parameter distribution formed by the similarity parameters generated on the sample images in the N groups of sample data and the corresponding standard images by the trained similarity recognition network. Therefore, a loss function L of the to-be-trained quality detection network (which may be referred to as a quality detection deviation of the to-be-trained quality detection network for the sample image) may be a square loss function shown in the following formula:

$$L ( Y / f ( X ) ) = {\sum }_{N} {( Y - f ( X ) )}^{2}$$

Y in the formula may represent a similarity parameter between a sample image in the N groups of sample data and a corresponding standard image, X may represent a sample image in the N groups of sample data, and f(X) may represent a quality parameter generated for the sample image X by the to-be-trained quality detection network. A square difference between Y and f(X) may be configured for representing a difference between the first parameter distribution (that is, parameter distribution formed by Y) and the second parameter distribution (that is, parameter distribution formed by f(X)). Therefore, an objective of updating the to-be-trained quality detection network is to cause the loss function L generated in each iteration process to approach a minimum value (for example, approach 0).

The computer device may continuously perform iterative modification (namely, iterative update) on the network parameter of the to-be-trained quality detection network by using the principle described above. When update of the network parameter of the to-be-trained quality detection network is completed (for example, when the quality detection network is trained to be in a convergence state or times of iterative training reaches a set time threshold), a trained quality detection network can be obtained.

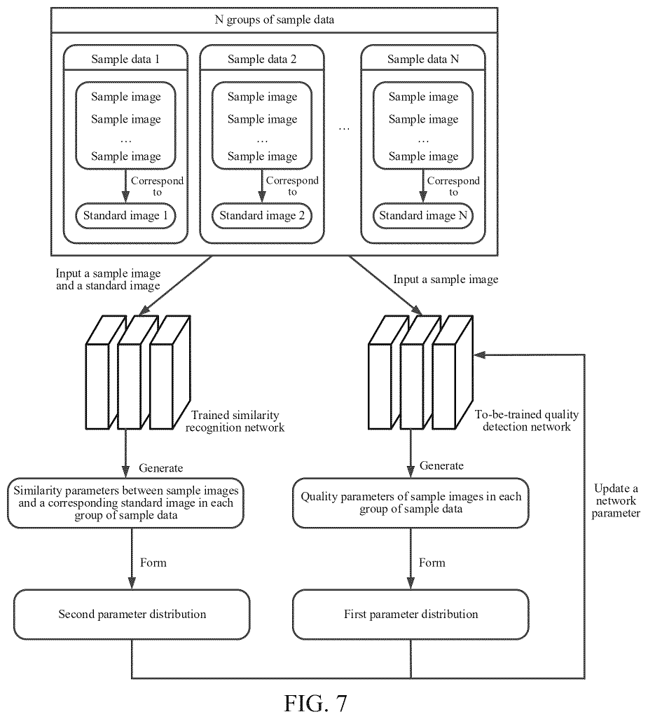

Refer to FIG. 7. FIG. 7 is a schematic diagram of a scenario of training a quality detection network according to an embodiment of this application. As shown in FIG. 7, the computer device may obtain N groups of sample data (including sample data 1 to sample data N herein). Each group of sample data may include several sample images and a standard image corresponding to the several sample images.

The computer device may input sample images and standard images in the N groups of sample data into the trained similarity recognition network, to invoke the similarity recognition network to generate a similarity parameter between a sample image and a corresponding standard image in each group of sample data. Similarity parameters between the sample images and the corresponding standard images in the N groups of sample data may form the second parameter distribution.

The computer device may also input the sample images in the N groups of sample data into the to-be-trained quality detection network, to invoke the to-be-trained quality detection network to generate the quality parameters of the sample images in the group of sample data. Quality parameters of sample images in the N groups of sample data may form the first parameter distribution.

Therefore, the computer device may update the network parameter of the to-be-trained quality detection network by using the difference between the first parameter distribution and the second parameter distribution. An objective of updating may be to cause the difference between the first parameter distribution and the second parameter distribution to approach the minimum (for example, approach 0), and finally the trained quality detection network may be obtained.

A conventional image quality detection algorithm comes from experience of various experts. Specific quality evaluation rules are respectively set by the experts for images of various types (for example, images of different image types). The algorithm needs to rely on expert knowledge, and different quality evaluation rules need to be designed for images of different types. Robustness to a complex scenario is insufficient. Therefore, according to the method for training a quality detection network designed in this embodiment of this application, a similarity between an image of poor image quality (for example, a sample image) and an image of optimal image quality (for example, a standard image) may assist training of the quality detection network so that the quality detection network may also generate a quality parameter of an input image corresponding to the similarity between an image of poor image quality (for example, a sample image) and an image of optimal image quality (for example, a standard image) Because the sample image of poor image quality may be diversified, by using the method provided in this embodiment of this application, accurate quality detection on images of various image types may be implemented by using a trained quality detection network, so that robustness of quality detection on images of various image types is improved.

In some embodiments, the first image may be acquired in real time when execution of a target service is triggered. The target service may be any service that needs to be performed by performing image recognition. For example, the target service may be a service of palm scanning payment, a service of palm scanning borrowing (for example, palm scanning for borrowing a power bank), or a service of palm scanning withdrawing. If the identity recognition information (which may be determined at any identity recognition stage) determined for the object to which the first image (or the second image) belongs is object identity information of a target object in the object set (which may be any object in the object set), the computer device may further obtain a service permission of the target object for the target service.

The computer device may execute the target service for the target object by using the service permission of the target object for the target service, that is, may execute the target service for the target object in a manner matching the service permission of the target object for the target service.

In some embodiments, the foregoing process of performing identity recognition on the object to which the first image belongs may alternatively be performed by the palm print image acquisition device. In this process, the palm print image acquisition device may obtain, from the computer device, relevant information needed for identity recognition (for example, relevant information stored in the background, such as the reference feature set, the image feature set associated with the target image type, and/or the image embedded feature stored in association with the input target object identification information). An execution entity specifically performing the process of performing identity recognition on the object to which the first image belongs may be determined based on an actual application scenario. This is not limited in this embodiment of this application.

In this manner, progressive accurate identity recognition on the object to which the first image belongs in identity recognition stages is implemented. In this process, before the user needs to input the object identification information, the object identity of the object to which the first image belongs is recognized with reference to the reference feature set and the image feature set associated with the target image type. Therefore, a possibility that the object identity of the object to which the first image belongs is recognized before the user needs to input the object identification information is increased, and accuracy of performing identity recognition on the object is improved, so that a frequency of inputting the object identification information by the object in the object set when performing image recognition is reduced, that is, operation complexity when performing image recognition is reduced, thereby improving image recognition efficiency.

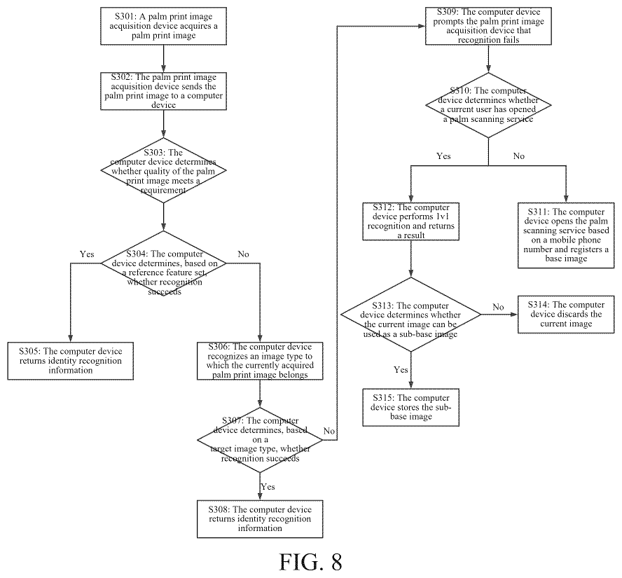

Refer to FIG. 8. FIG. 8 is a schematic flowchart of performing recognition on an identity of an object according to an embodiment of this application. As shown in FIG. 8, the flowchart may include the following operations.
Operation S301: A palm print image acquisition device acquires a palm print image.

In some embodiments, when the user scans the palm on the palm print image acquisition device, the user may align the palm to a camera component of the palm print image acquisition device, and the palm print image acquisition device acquires the palm print image (for example, the second image) by using the camera component.
Operation S302: The palm print image acquisition device sends the palm print image to a computer device.
Operation S303: The computer device determines whether quality of the palm print image meets a requirement.

In some embodiments, the computer device performs quality detection on the palm print image, to determine whether image quality of the palm print image sent by the palm print image acquisition device meets the requirement. The quality detection may also be implemented by using the trained quality detection network, for example, detecting whether a quality parameter of the palm print image is greater than a set threshold. Because a requirement for detection may be less than a requirement for storage as a base image, the threshold may be less than the quality parameter threshold. If the image quality of the palm print image is detected to meet the requirement, operation S304 may be performed. If the image quality of the palm print image is detected to not meet the requirement, the computer device may prompt the palm print image acquisition device to directly require the user to enter the palm print image again and discard the currently acquired palm print image.
Operation S304: The computer device determines, based on a reference feature set, whether recognition succeeds.

The object identity of the object may be recognized by using the second embedded feature of the palm print image and the reference feature set. The computer device may determine, based on the reference feature set, whether recognition on the currently acquired image succeeds, that is, determine whether the object identity of an object to which the currently acquired image (for example, the second image) belongs is successfully recognized by using the reference feature set. If recognition succeeds, operation S305 may be performed. If recognition fails, operation S306 may be performed.
Operation S305: The computer device returns identity recognition information.

In some embodiments, the computer device returns identity recognition information recognized on the object to which the currently acquired image belongs. For example, the returned identity recognition information may be the object identity information of the first recognition object.
Operation S306: The computer device recognizes an image type to which the currently acquired palm print image belongs.

For example, the recognized image type may be the target image type.
Operation S307: The computer device determines, based on a target image type, whether recognition succeeds.

In some embodiments, when performing recognition by using the target image type, the computer device may perform recognition based on the image feature set associated with the target image type. The image feature set includes image embedded features of images of objects in the object set in the target image type. Therefore, a recognition process is a process of recognizing the object identity of the object by using the first embedded feature and the image feature set associated with the target image type. If recognition succeeds, the computer device may perform operation S308. If recognition fails, the computer device may perform operation S309.
Operation S308: The computer device returns identity recognition information.

The returned identity recognition information may be the object identity information of the second recognition object.
Operation S309: The computer device prompts the palm print image acquisition device that recognition fails.

The computer device prompts the palm print image acquisition device that recognition fails, so that the palm print image acquisition device requires the user to input the object identification information (for example, the mobile phone number), and the palm print image acquisition device may return the mobile phone number input by the user to the computer device.
Operation S310: The computer device determines whether a current user has opened a palm scanning service.

Whether the palm scanning service is opened is determined, that is, whether the mobile phone number input by the user has been registered for the palm scanning service is determined. If the mobile phone number has been registered, operation S312 may be performed. If the mobile phone number has not been registered, operation S311 may be performed.
Operation S311: The computer device opens the palm scanning service based on a mobile phone number and registers a base image.

The computer device may open (that is, register) the palm scanning service for the mobile phone number currently input by the user, and may register the base image of the user. Registering the base image of the user herein may be requiring the user to input the reference image in the reference pose, so that the computer device may store the reference embedded feature of the reference image of the user, to register the palm print image of the user.
Operation S312: The computer device performs 1v1 recognition and returns a result.

The computer device may perform 1v1 recognition on the user by using the mobile phone number input by the user and return an identity recognition result. The 1v1 recognition process is the process of performing identity recognition on the object to which the currently acquired image belongs by using the target embedded feature associated with the target object identification information input by the user and the third embedded feature.
Operation S313: The computer device determines whether the current image can be used as a sub-base image.

In some embodiments, the current image is a palm print image currently captured by a palm print image acquisition device. The computer device may detect the image quality of the current image by using the trained quality detection network. If the quality parameter of the current image is greater than or equal to the quality parameter threshold, it indicates that the current image can be used as the sub-base image. On the contrary, if the quality parameter of the current image is less than the quality parameter threshold, it indicates that the current image cannot be used as the sub-base image. If the current image can be used as the sub-base image, the computer device may perform operation S315. If the current image cannot be used as the sub-base image, the computer device may perform operation S314.
Operation S314: The computer device discards the current image.
Operation S315: The computer device stores the sub-base image.

The current image may be stored as the sub-base image, or an image embedded feature of the current image may be stored as the sub-base image. For example, the image embedded feature of the current image may be used as an image embedded feature of a target image of an object to which the image belongs under the target image type.

By means of the foregoing process, three progressive identity recognition processes are performed on user identity of the user, to implement accurate and efficient recognition on the user identity of the user.

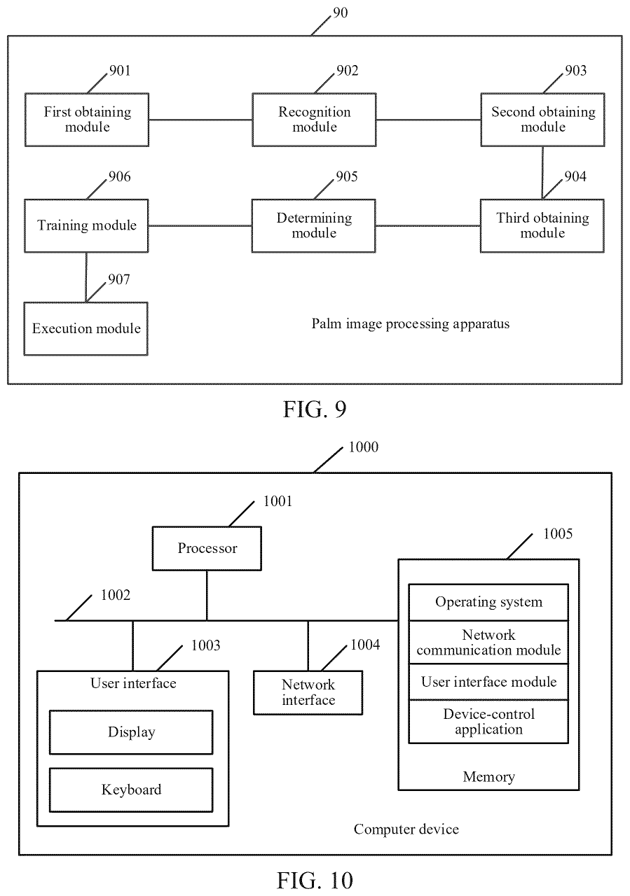

Refer to FIG. 9. FIG. 9 is a schematic structural diagram of an image processing apparatus according to an embodiment of this application. As shown in FIG. 9, an image processing apparatus 90 may include: a first obtaining module 901, a recognition module 902, a second obtaining module 903, a third obtaining module 904, and a determining module 905.

The first obtaining module 901 is configured to obtain a to-be-recognized first image and a first embedded feature of the first image, the first image being a palm print image; the recognition module 902 is configured to recognize a target image type to which the first image belongs; the second obtaining module 903 is configured to obtain an image feature set associated with the target image type, the image feature set including image embedded features of target images of a plurality of objects, the target images being palm print images that belong to the target image type, and each object having respective object identity information; the third obtaining module 904 is configured to obtain a feature matching degree between the first embedded feature and each image embedded feature; and the determining module 905 is configured to determine, based on the object identity information of each object and the feature matching degree between the first embedded feature and the image embedded feature, identity recognition information for an object to which the first image belongs.

In some embodiments, a flowchart of obtaining the first image by the first obtaining module 901 includes: obtaining a second image acquired for a palm, and performing feature extraction on the second image, to generate a second embedded feature of the second image; obtaining a reference feature set, the reference feature set including reference embedded features of a plurality of reference images, and the reference images being palm print images of the objects in a reference pose; obtaining a feature matching degree between the second embedded feature and each reference embedded feature; and determining the second image as the first image if the feature matching degree between the second embedded feature and each reference embedded feature is less than a first matching degree threshold.

In some embodiments, the first obtaining module 901 is further configured to: select, from the reference feature set, a reference embedded feature whose feature matching degree with the second embedded feature is greater than or equal to the first matching degree threshold as a first candidate embedded feature; determine an object to which a first candidate embedded feature having a largest feature matching degree with the second embedded feature belongs as a first recognition object; and determine object identity information of the first recognition object as identity recognition information for an object to which the second image belongs.

In some embodiments, a manner of determining, by the determining module 905 based on the object identity information of each object and the feature matching degree between the first embedded feature and the image embedded feature, the identity recognition information for the object to which the first image belongs includes: obtaining, if the feature matching degree between the first embedded feature and the image embedded feature is less than a second matching degree threshold, target object identification information of the object to which the first image belongs; performing feature extraction on the first image, to generate a third embedded feature of the first image; and determining, based on the target object identification information and the third embedded feature, the identity recognition information for the object to which the first image belongs.

In some embodiments, the determining module 905 is further configured to: determine, from the image feature set, a second candidate embedded feature, a feature matching degree between the second candidate embedded feature and the first embedded feature being greater than or equal to the second matching degree threshold; determine an object to which a second candidate embedded feature having a largest feature matching degree with the first embedded feature belongs as a second recognition object; and determine object identity information of the second recognition object as the identity recognition information for the object to which the first image belongs.

In some embodiments, each object has a respective reference embedded feature of a reference image in the reference pose, and the reference embedded feature corresponding to each object is stored respectively associated with object identification information of each object; and a manner of determining, by the determining module 905 based on the target object identification information and the third embedded feature, the identity recognition information for the object to which the first image belongs includes: determining the reference embedded feature stored in association with the target object identification information as a target embedded feature; obtaining a feature matching degree between the target embedded feature and the third embedded feature; and determining, if the feature matching degree between the target embedded feature and the third embedded feature is greater than or equal to a third matching degree threshold, object identity information of an object to which the target embedded feature belongs as the identity recognition information for the object to which the first image belongs.

In some embodiments, the first image is acquired by a palm print image acquisition device; and the determining module 905 is further configured to: generate recognition failure information if the feature matching degree between the target embedded feature and the third embedded feature is less than the third matching degree threshold; and return the recognition failure information to the palm print image acquisition device, so that the palm print image acquisition device outputs, based on the recognition failure information, prompt information indicating that image acquisition needs to be performed again.

In some embodiments, the determining module 905 is further configured to: detect image quality of the first image if the feature matching degree between the target embedded feature and the third embedded feature is greater than or equal to the third matching degree threshold; and determine, if the image quality of the first image meets a set quality standard, the first embedded feature or the third embedded feature as an image embedded feature of an image of the object to which the first image belongs in the target image type.

In some embodiments, a manner of detecting the image quality of the first image by the determining module 905 includes: inputting the first image into a trained quality detection network; and invoking the trained quality detection network to perform quality detection on the first image, to generate a quality parameter of the first image, the quality parameter of the first image being configured for reflecting the image quality of the first image. The quality standard including a set quality parameter threshold, and the determining module is further configured to determine, if the quality parameter of the first image is greater than or equal to the quality parameter threshold, that the image quality of the first image complies with the quality standard.

In some embodiments, the determining module 905 is further configured to: determine, if the quality parameter of the first image is less than the quality parameter threshold, that the image quality of the first image does not comply with the quality standard; and reject to store the first embedded feature or the third embedded feature of the first image.

In some embodiments, the image processing apparatus further includes a training module 906. The training module 906 is configured to: obtain a to-be-trained quality detection network and a sample data set, the sample data set including N groups of sample data, N being a positive integer, and one group of sample data including a to-be-detected sample image and a standard image of a sample palm to which the sample image belongs; invoke a trained similarity recognition network to perform recognition on a similarity between a sample images and a corresponding standard image in each group of sample data, to generate a similarity parameter between the sample image and the corresponding standard image in the group of sample data; invoke the to-be-trained quality detection network to perform quality detection on the sample image in the group of sample data, to generate a quality parameter of the sample image in the group of sample data; and update a network parameter of the to-be-trained quality detection network based on the similarity parameter between the sample image and the corresponding standard image in the group of sample data and the quality parameter of the sample image in the group of sample data, to obtain the trained quality detection network.

In some embodiments, a manner of updating the network parameter of the to-be-trained quality detection network by the training module 906 includes: updating the network parameter of the to-be-trained quality detection network, to cause first parameter distribution to approach second parameter distribution, the first parameter distribution being parameter distribution formed by quality parameters of sample images in the N groups of sample data, and the second parameter distribution being parameter distribution formed by similarity parameters between the sample images and corresponding standard images in the N groups of sample data.

In some embodiments, a manner of recognizing, by the recognition module 902 from a plurality of set image types, the target image type to which the first image belongs includes: inputting the first image into a trained multi-classification network; and invoking the trained multi-classification network to recognize, from a plurality of set image types, the target image type to which the first image belongs.

In some embodiments, the first image is acquired by the palm print image acquisition device; the plurality of image types includes a large-angle image type; and a manner of recognizing, by the recognition module 902 from a plurality of set image types, the target image type to which the first image belongs includes: obtaining a target angle between an image plane corresponding to the first image and a coordinate system in which the palm print image acquisition device is located; and determining, if the target angle is larger than a set angle threshold, a first image type as the target image type to which the first image belongs.

In some embodiments, a manner of obtaining, by the third obtaining module 904, the feature matching degree between the first embedded feature and the image embedded feature in the image feature set includes: calculating a cosine similarity between the first embedded feature and each image embedded feature in the image feature set; and determining the cosine similarity between the first embedded feature and the image embedded feature in the image feature set as the feature matching degree between the first embedded feature and the image embedded feature in the image feature set.

In some embodiments, the first image is acquired in real time when execution of a target service is triggered; and the image processing apparatus further includes an execution module 907, and the execution module 907 is configured to: obtain, if the identity recognition information determined for the object to which the first image belongs is object identity information of a target object in the object set, a service permission of the target object for the target service; and execute the target service for the target object based on the service permission of the target object for the target service.

According to an embodiment of this application, operations involved in the image processing method shown in FIG. 3 may be performed by the modules in the image processing apparatus 90 shown in FIG. 9. For example, operation S101 shown in FIG. 3 may be performed by the first obtaining module 901 in FIG. 9, operation S102 shown in FIG. 3 may be performed by the recognition module 902 in FIG. 9, operation S103 shown in FIG. 3 may be performed by the second obtaining module 903 in FIG. 9, operation S104 shown in FIG. 3 may be performed by the third obtaining module 904 in FIG. 9, and operation S105 shown in FIG. 3 may be performed by the determining module 905 in FIG. 9.

In this application, a to-be-recognized first image and a first embedded feature of the first image may be obtained; a target image type to which the first image belongs may be recognized from a plurality of set image types; an image feature set associated with the target image type may be obtained; the image feature set including image embedded features of images of a plurality of objects in an object set in the target image type, and each object in the object set having respective object identity information; a feature matching degree between the first embedded feature and each image embedded feature in the image feature set may be obtained; and identity recognition information for an object to which the first image belongs may be determined based on the object identity information of each object and the feature matching degree between the first embedded feature and the image embedded feature in the image feature set. It can be learned that according to the apparatus provided in embodiments of this application, a specific target image type to which the first image belongs may be first recognized, so that identity recognition on the object to which the first image belongs may be implemented by using a specific image feature set associated with the specific target image type and an embedded feature (for example, the first embedded feature) of the first image. Recognition in a specific range (for example, the image feature set associated with the target image type) is performed on an image considering a specific type of the image, so that recognition on an identity of an object to which the image belongs is implemented, thereby improving accuracy of identity recognition on the object through the image.

According to an embodiment of this application, modules in the image processing apparatus 90 shown in FIG. 9 may be separately or wholly combined into one or several units, or one (or more) of the units herein may further be divided into a plurality of subunits of smaller functions. In this way, same operations can be implemented, and implementation of the technical effects of the embodiments of this application is not affected. The foregoing modules are divided based on logical functions. In practical application, a function of one module may be implemented by a plurality of units, or functions of a plurality of modules are implemented by one unit. In other embodiments of this application, the image processing apparatus 90 may further include another unit. In an actual application, these functions may also be cooperatively implemented by another unit, and may be implemented through collaboration by a plurality of units.

In embodiments of this application, the term “module” or “unit” refers to a computer program having a predetermined function or a part of a computer program, and works together with other relevant parts to achieve a predetermined objective, and may be completely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or the unit.

According to an embodiment of this application, a computer program that can perform operations involved in the corresponding method shown in embodiments of this application may be run on a general-purpose computer device (the computer device may include processing elements and storage elements such as a central processing unit (CPU), a random access memory (RAM), and a read-only memory (ROM)), to construct the image processing apparatus 90 as shown in FIG. 9. The computer program may be recorded in, for example, a computer-readable recording medium, and may be loaded into the computer device by using the computer-readable recording medium, and run in the computer device.

Refer to FIG. 10. FIG. 10 is a schematic structural diagram of a computer device according to an embodiment of this application. As shown in FIG. 10, a computer device 1000 may include: a processor 1001, a network interface 1004, and a memory 1005. In addition, the computer device 1000 may further include: a user interface 1003 and at least one communication bus 1002. The communication bus 1002 is configured to implement connection and communication among the components. The user interface 1003 may include a display and a keyboard, and in some embodiments, the user interface 1003 may further include a standard wired interface and a standard wireless interface. The network interface 1004 may include a standard wired interface and a standard wireless interface (for example, a WI-FI interface). The memory 1005 may be a high-speed RAM memory, or may be a non-volatile memory, for example, at least one magnetic disk memory. The memory 1005 may further be at least one storage apparatus away from the processor 1001. As shown in FIG. 10, the memory 1005, which is used as a computer storage medium, may include an operating system, a network communication module, a user interface module, and a device-control application.

In the computer device 1000 shown in FIG. 10, the network interface 1004 may provide a network communication function. The user interface 1003 is mainly configured to provide an input interface for a user. The processor 1001 may be configured to invoke the device-control application stored in the memory 1005, to implement: obtaining a to-be-recognized first image and a first embedded feature of the first image; recognizing a target image type to which the first image belongs; obtaining an image feature set associated with the target image type, the image feature set including image embedded features of target images of a plurality of objects, the target images being palm print images that belong to the target image type, and each object having respective object identity information; obtaining a feature matching degree between the first embedded feature and each image embedded feature; and determining, based on the object identity information of each object and the feature matching degree between the first embedded feature and the image embedded feature, identity recognition information for an object to which the first image belongs.

In some embodiments, the processor 1001 may be configured to invoke the device-control application stored in the memory 1005, to implement: obtaining a second image acquired for a palm, and performing feature extraction on the second image, to generate a second embedded feature of the second image; obtaining a reference feature set, the reference feature set including reference embedded features of reference images of objects in an object set in a reference pose; obtaining a feature matching degree between the second embedded feature and each reference embedded feature; and determining the second image as the first image if the feature matching degree between the second embedded feature and each reference embedded feature is less than a first matching degree threshold.

In some embodiments, the processor 1001 is further configured to invoke the device-control application stored in the memory 1005, to implement: determining, from the reference feature set, a first candidate embedded feature, a feature matching degree between the first candidate embedded feature and the second embedded feature being greater than or equal to the first matching degree threshold; determining an object to which a first candidate embedded feature having a largest feature matching degree with the second embedded feature belongs as a first recognition object; and determining object identity information of the first recognition object as the identity recognition information for the object to which the second image belongs.

In some embodiments, the processor 1001 may be further configured to invoke the device-control application stored in the memory 1005, to implement: obtaining, if the feature matching degree between the first embedded feature and the image embedded feature is less than a second matching degree threshold, target object identification information of the object to which the first image belongs; performing feature extraction on the first image, to generate a third embedded feature of the first image; and determining, based on the target object identification information and the third embedded feature, the identity recognition information for the object to which the first image belongs.

In some embodiments, the processor 1001 may be further configured to invoke the device-control application stored in the memory 1005, to implement: determining, from the image feature set, a second candidate embedded feature, a feature matching degree between the second candidate embedded feature and the first embedded feature being greater than or equal to the second matching degree threshold; determining an object to which a second candidate embedded feature having a largest feature matching degree with the first embedded feature belongs as a second recognition object; and determining object identity information of the second recognition object as the identity recognition information for the object to which the first image belongs.

In some embodiments, each object has a respective reference embedded feature of a reference image in the reference pose, and the reference embedded feature corresponding to each object is stored respectively associated with object identification information of each object, and the processor 1001 may be further configured to invoke the device-control application stored in the memory 1005, to implement: determining the reference embedded feature stored in association with the target object identification information as a target embedded feature; obtaining a feature matching degree between the target embedded feature and the third embedded feature; and determining, if the feature matching degree between the target embedded feature and the third embedded feature is greater than or equal to a third matching degree threshold, object identity information of an object to which the target embedded feature belongs as the identity recognition information for the object to which the first image belongs.

In some embodiments, the first image is acquired by a palm print image acquisition device; and the processor 1001 may be further configured to invoke the device-control application stored in the memory 1005, to implement: generating recognition failure information if the feature matching degree between the target embedded feature and the third embedded feature is less than the third matching degree threshold; and returning the recognition failure information to the palm print image acquisition device, so that the palm print image acquisition device outputs, based on the recognition failure information, prompt information indicating that image acquisition needs to be performed again.

In some embodiments, the processor 1001 may be further configured to invoke the device-control application stored in the memory 1005, to implement: detecting image quality of the first image if the feature matching degree between the target embedded feature and the third embedded feature is greater than or equal to the third matching degree threshold; and storing, if the image quality of the first image meets a set quality standard, the first embedded feature or the third embedded feature as an image embedded feature of an image of the object to which the first image belongs in the target image type.

In some embodiments, the processor 1001 may be further configured to invoke the device-control application stored in the memory 1005, to implement: inputting the first image into a trained quality detection network; and invoking the trained quality detection network to perform quality detection on the first image, to generate a quality parameter of the first image, the quality parameter of the first image being configured for reflecting the image quality of the first image. The quality standard includes a set quality parameter threshold, and the processor 1001 may be further configured to invoke the device-control application stored in the memory 1005, to implement: determining, if the quality parameter of the first image is greater than or equal to the quality parameter threshold, that the image quality of the first image complies with the quality standard.

In some embodiments, the processor 1001 may be further configured to invoke the device-control application stored in the memory 1005, to implement: determining, if the quality parameter of the first image is less than the quality parameter threshold, that the image quality of the first image does not comply with the quality standard; and rejecting to store the first embedded feature or the third embedded feature of the first image.

In some embodiments, the processor 1001 may be further configured to invoke the device-control application stored in the memory 1005, to implement: obtaining a to-be-trained quality detection network and a sample data set, the sample data set including N groups of sample data, N being a positive integer, and one group of sample data including a to-be-detected sample image and a standard image of a sample palm to which the sample image belongs; invoking a trained similarity recognition network to perform recognition on a similarity between a sample image and a corresponding standard image in each group of sample data, to generate a similarity parameter between the sample image and the corresponding standard image in the group of sample data; invoking the to-be-trained quality detection network to perform quality detection on the sample image in the group of sample data, to generate a quality parameter of the sample image in the group of sample data; and updating a network parameter of the to-be-trained quality detection network based on the similarity parameter between the sample image and the corresponding standard image in the group of sample data and the quality parameter of the sample image in the group of sample data, to obtain the trained quality detection network.

In some embodiments, a manner of updating the network parameter of the to-be-trained quality detection network includes: updating the network parameter of the to-be-trained quality detection network, to cause first parameter distribution to approach second parameter distribution, the first parameter distribution being parameter distribution formed by quality parameters of sample images in the N groups of sample data, and the second parameter distribution being parameter distribution formed by similarity parameters between the sample images and corresponding standard images in the N groups of sample data.

In some embodiments, the processor 1001 may be further configured to invoke the device-control application stored in the memory 1005, to implement: inputting the first image into the trained multi-classification network; and invoking the trained multi-classification network to recognize, from the plurality of set image types, the target image type to which the first image belongs.

In some embodiments, the first image is acquired by the palm print image acquisition device; the plurality of image types includes the first image type; and the processor 1001 may be further configured to invoke the device-control application stored in the memory 1005, to implement: obtaining a target angle between an image plane corresponding to the first image and a coordinate system in which the palm print image acquisition device is located; and determining, if the target angle is larger than a set angle threshold, the first image type as the target image type to which the first image belongs.

In some embodiments, the processor 1001 may be further configured to invoke the device-control application stored in the memory 1005, to implement: calculating a cosine similarity between the first embedded feature and each image embedded feature; and determining the cosine similarity between the first embedded feature and the image embedded feature as the feature matching degree between the first embedded feature and the image embedded feature.

In some embodiments, the first image is acquired in real time when execution of a target service is triggered; and the processor 1001 may be further configured to invoke the device-control application stored in the memory 1005, to implement: obtaining, if the identity recognition information determined for the object to which the first image belongs is object identity information of a target object in the object set, a service permission of the target object for the target service; and executing the target service for the target object based on the service permission of the target object for the target service.

The computer device 1000 described in this embodiment of this application may perform the description of the image processing method in embodiments of this application, or may perform the description of the image processing apparatus 90 in the embodiment corresponding to FIG. 9. In addition, beneficial effects of the same method are the same.

In addition, an embodiment of this application further provides a non-transitory computer-readable storage medium, the computer-readable storage medium having a computer program stored therein, and a processor, when executing the computer program, can perform the description of the image processing method in embodiments of this application. In addition, beneficial effects of the same method are the same. For technical details that are not disclosed in embodiments of the computer storage medium involved in this application, refer to the description of method embodiments of this application.

For example, the foregoing computer program may be deployed on one computer device for execution, or may be deployed on a plurality of computer devices located at one site for execution, or may be executed on a plurality of computer devices that are distributed on a plurality of sites and that are interconnected through a communication network. The plurality of computer devices that are distributed on a plurality of sites and that are interconnected through a communication network may form a blockchain network.

The computer-readable storage medium may be an internal storage unit of the computer device, for example, a hard disk or an internal memory of the computer device. The computer-readable storage medium may alternatively be an external storage device of the computer device, for example, a plug type hard disk, a smart media card (SMC), a secure digital (SD) card, and a flash card that are configured on the computer device. Further, the computer-readable storage medium may further include both an internal storage unit and an external storage device of the computer device. The computer-readable storage medium is configured to store the computer program and other programs and data that are required by the computer device. The computer-readable storage medium may be further configured to temporarily store data that has been outputted or is to be outputted.

An embodiment of this application provides a computer program product, the computer program product including a computer program, and the computer program being stored in a non-transitory computer-readable storage medium. A processor of a computer device reads the computer program from the computer-readable storage medium, and the processor executes the computer program, so that the computer device performs the image processing method in embodiments of this application. In addition, beneficial effects of the same method are the same. For technical details that are not disclosed in embodiments of the computer-readable storage medium involved in this application, refer to the description of method embodiments of this application.

The terms “first”, “second”, and the like in the specification, claims, and accompanying drawings of embodiments of this application are configured for distinguishing between different objects, and are not configured for describing a specific sequence. In addition, the term “include” and any variation thereof are intended to cover a non-exclusive inclusion. For example, a process, a method, an apparatus, a product, or a device including a series of operations or units is not limited to the listed operations or modules, but instead, some embodiments include operations or modules not listed, or some embodiments include other operations or units inherent to the process, the method, the apparatus, the product, or the device.

A person of ordinary skill in the art may be aware that, in combination with the examples described in embodiments disclosed in this specification, units and algorithm operations may be implemented by electronic hardware, computer software, or a combination thereof. To clearly describe the interchangeability between the hardware and the software, the foregoing has generally described compositions and operations of each example according to functions. Whether the functions are executed in the form of hardware or software depends on particular applications and design constraint conditions of the technical solutions. A person skilled in the art may use different methods to implement the described functions for each particular application, but the implementation shall not be considered beyond the scope of this application.

What is disclosed above is merely exemplary embodiments of this application, and certainly is not intended to limit the protection scope of this application. Therefore, equivalent variations made in accordance with the claims of this application shall fall within the scope of this application.

What is claimed is:

1. An image processing method performed by a computer device, the method comprising:
obtaining a first embedded feature of a first image, the first image being a palm print image;
recognizing a target image type to which the first image belongs;
obtaining an image feature set associated with the target image type, the image feature set comprising image embedded features of target images of a plurality of objects, each object having respective object identity information;
determining a feature matching degree between the first embedded feature and each image embedded feature in the image feature set; and
determining, among the plurality of objects, object identity information of an object whose associated image embedded feature has a highest feature matching degree with the first embedded feature for an object to which the first image belongs.

2. The method according to claim 1, wherein the obtaining a first embedded feature of a first image comprises:
performing feature extraction on a second image of a palm, to obtain a second embedded feature of the second image;
obtaining a reference feature set, the reference feature set comprising reference embedded features of a plurality of reference images, and the reference images being palm print images of the objects in a reference pose;
obtaining a feature matching degree between the second embedded feature and each reference embedded feature; and
determining the second image as the first image when the feature matching degree between the second embedded feature and each reference embedded feature is less than a first matching degree threshold.

3. The method according to claim 1, wherein the method further comprises:
determining a first candidate embedded feature from a reference feature set, the feature matching degree between the first candidate embedded feature and the second embedded feature being greater than or equal to the first matching degree threshold;
determining an object to which a first candidate embedded feature having a largest feature matching degree with the second embedded feature belongs as a first recognition object; and
determining object identity information of the first recognition object as identity recognition information for an object to which the second image belongs.

4. The method according to claim 1, wherein the determining, among the plurality of objects, object identity information of an object whose associated image embedded feature has a highest feature matching degree with the first embedded feature for an object to which the first image belongs comprises:
obtaining, when the feature matching degree between the first embedded feature and the image embedded feature is less than a second matching degree threshold, target object identification information of the object to which the first image belongs;
performing feature extraction on the first image, to generate a third embedded feature of the first image; and
determining, based on the target object identification information and the third embedded feature, the identity recognition information for the object to which the first image belongs.

5. The method according to claim 1, wherein the method further comprises:
determining a second candidate embedded feature from the image feature set, a feature matching degree between the second candidate embedded feature and the first embedded feature being greater than or equal to a second matching degree threshold;
determining an object to which a second candidate embedded feature having the highest feature matching degree with the second embedded feature belongs as a second recognition object; and
determining the object identity information of the second recognition object as the identity recognition information for the object to which the first image belongs.

6. The method according to claim 1, wherein the recognizing a target image type to which the first image belongs comprises:
inputting the first image into a trained multi-classification network; and
invoking the trained multi-classification network to recognize, from a plurality of set image types, the target image type to which the first image belongs.

7. The method according to claim 1, wherein the first image is acquired by the palm print image acquisition device; and
the recognizing a target image type to which the first image belongs comprises:
obtaining a target angle between an image plane corresponding to the first image and a coordinate system in which the palm print image acquisition device is located; and
determining, when the target angle is larger than a set angle threshold, a first image type as the target image type to which the first image belongs.

8. The method according to claim 1, wherein the determining a feature matching degree between the first embedded feature and each image embedded feature in the image feature set comprises:
determining a cosine similarity between the first embedded feature and each image embedded feature in the image feature set; and
determining the cosine similarity between the first embedded feature and the image embedded features as the feature matching degree between the first embedded feature and the image embedded feature.

9. The method according to claim 1, wherein the first image is acquired in real time when execution of a target service is triggered; and the method further comprises:
obtaining, when the identity recognition information determined for the object to which the first image belongs is object identity information of a target object, a service permission of the target object for the target service; and
executing the target service for the target object based on the service permission of the target object for the target service.

10. A computer device, comprising a memory and a processor, the memory having a computer program stored therein, and the computer program, when executed by the processor, causing the computer device to perform an image processing method including:
obtaining a first embedded feature of a first image, the first image being a palm print image;
recognizing a target image type to which the first image belongs;
obtaining an image feature set associated with the target image type, the image feature set comprising image embedded features of target images of a plurality of objects, each object having respective object identity information;
determining a feature matching degree between the first embedded feature and each image embedded feature in the image feature set; and
determining, among the plurality of objects, object identity information of an object whose associated image embedded feature has a highest feature matching degree with the first embedded feature for an object to which the first image belongs.

11. The computer device according to claim 10, wherein the obtaining a first embedded feature of a first image comprises:
performing feature extraction on a second image of a palm, to obtain a second embedded feature of the second image;
obtaining a reference feature set, the reference feature set comprising reference embedded features of a plurality of reference images, and the reference images being palm print images of the objects in a reference pose;
obtaining a feature matching degree between the second embedded feature and each reference embedded feature; and
determining the second image as the first image when the feature matching degree between the second embedded feature and each reference embedded feature is less than a first matching degree threshold.

12. The computer device according to claim 10, wherein the method further comprises:
determining a first candidate embedded feature from a reference feature set, the feature matching degree between the first candidate embedded feature and the second embedded feature being greater than or equal to the first matching degree threshold;
determining an object to which a first candidate embedded feature having a largest feature matching degree with the second embedded feature belongs as a first recognition object; and
determining object identity information of the first recognition object as identity recognition information for an object to which the second image belongs.

13. The computer device according to claim 10, wherein the determining, among the plurality of objects, object identity information of an object whose associated image embedded feature has a highest feature matching degree with the first embedded feature for an object to which the first image belongs comprises:
obtaining, when the feature matching degree between the first embedded feature and the image embedded feature is less than a second matching degree threshold, target object identification information of the object to which the first image belongs;
performing feature extraction on the first image, to generate a third embedded feature of the first image; and
determining, based on the target object identification information and the third embedded feature, the identity recognition information for the object to which the first image belongs.

14. The computer device according to claim 10, wherein the method further comprises:
determining a second candidate embedded feature from the image feature set, a feature matching degree between the second candidate embedded feature and the first embedded feature being greater than or equal to a second matching degree threshold;
determining an object to which a second candidate embedded feature having the highest feature matching degree with the second embedded feature belongs as a second recognition object; and
determining the object identity information of the second recognition object as the identity recognition information for the object to which the first image belongs.

15. The computer device according to claim 10, wherein the recognizing a target image type to which the first image belongs comprises:
inputting the first image into a trained multi-classification network; and
invoking the trained multi-classification network to recognize, from a plurality of set image types, the target image type to which the first image belongs.

16. The computer device according to claim 10, wherein the first image is acquired by the palm print image acquisition device; and
the recognizing a target image type to which the first image belongs comprises:
obtaining a target angle between an image plane corresponding to the first image and a coordinate system in which the palm print image acquisition device is located; and
determining, when the target angle is larger than a set angle threshold, a first image type as the target image type to which the first image belongs.

17. The computer device according to claim 10, wherein the determining a feature matching degree between the first embedded feature and each image embedded feature in the image feature set comprises:
determining a cosine similarity between the first embedded feature and each image embedded feature in the image feature set; and
determining the cosine similarity between the first embedded feature and the image embedded features as the feature matching degree between the first embedded feature and the image embedded feature.

18. The computer device according to claim 10, wherein the first image is acquired in real time when execution of a target service is triggered; and the method further comprises:
obtaining, when the identity recognition information determined for the object to which the first image belongs is object identity information of a target object, a service permission of the target object for the target service; and
executing the target service for the target object based on the service permission of the target object for the target service.

19. A non-transitory computer-readable storage medium having a computer program stored therein, and the computer program, when executed by a processor of a computer device, causing the computer device to perform an image processing method including:
obtaining a first embedded feature of a first image, the first image being a palm print image;
recognizing a target image type to which the first image belongs;
obtaining an image feature set associated with the target image type, the image feature set comprising image embedded features of target images of a plurality of objects, each object having respective object identity information;
determining a feature matching degree between the first embedded feature and each image embedded feature in the image feature set; and
determining, among the plurality of objects, object identity information of an object whose associated image embedded feature has a highest feature matching degree with the first embedded feature for an object to which the first image belongs.

20. The non-transitory computer-readable storage medium according to claim 19, wherein the first image is acquired in real time when execution of a target service is triggered; and the method further comprises:
obtaining, when the identity recognition information determined for the object to which the first image belongs is object identity information of a target object, a service permission of the target object for the target service; and
executing the target service for the target object based on the service permission of the target object for the target service.
